(19) United States
(12) Patent Application Publication
(10) Pub. No.: US 2016/0100714 A1
(43) Pub. Date: Apr. 14, 2016

(54) Barbecue Grill

(71) Applicant: Bijan Dokhanian, Beverly Hills, CA (US)

(72) Inventors: Bijan Dokhanian, Beverly Hills, CA (US); Zoltan Kemeny, Chandler, AZ (US)

(21) Appl. No.: 14/757,263

(22) Filed: Dec. 10, 2015

(51) Int. Cl. A47J 37/07; F24B 3/00

(52) U.S. Cl. CPC A47J 37/0763; F24B 3/00

(57) ABSTRACT

Disclosed is high mobility outdoor barbeque grill apparatus having one or two lids opening sideway, so upon opening the lid(s), smoked won't get into the eyes of the cook or his/her friends, who may stand on the other side of the grill. The proposed novel grill is height adjustable, via foldable scissor underframe and its handle bars are lockable in upright or down ward position, so when stored in a garage, it requires only a small space. Its large wheels allow for grass and sand negotiation without sinking deep. The lid is preferably transparent, so the cook may not need to open the lid frequently. The proposed grill is also built with rigid, non-collapsible frame.

### FIELD OF THE INVENTION

This invention relates to mobile barbecue grill with sideways opening lids.

### BACKGROUND OF THE INVENTION

The invention fulfills the need for a barbecue grill, which can be rolled outdoors, say from the home garage, be raised or lowered to accommodate short or tall chefs, and has transparent lids opening sideways, so the smoke would not hit the chef or the bystanders, family members or guests, standing in front of the hot grill, as it happens with state-of-art, always backward opening grill lids.

State-of-art outdoor barbeque grills have small caster legs, unsuitable to drag on sand and grass. They are heavy and bulky. Their height is fixed, which may be uncomfortable to too short and too tall chefs. Their lid opens from front to rear. That drives smoke to the cook and friends face, who stands in front of the grill. That alone caused numerous accidents in the past. Some were quite serious. That also allows for more cooks or friends standing on both sides of the grill. It is difficult to find a suitable space for a state-of-art outdoor grill in a typical home garage, which is often jammed already.

It is therefore the object of the invention to remedy the listed weaknesses, provide solutions for the cited problems and ensure the means to satisfy the requirements listed for the desired grill.

### SUMMARY OF THE INVENTION

The above problems and others are at least partially solved and the above objects and others realized in a process, which according to the teachings of this invention, uses a high mobility outdoor grill with the following minimum features:
a) Split lid with each half opening sideways, forcing smoke upward upon lid opening and allowing cooks to standby on both sides of the grill;
b) Transparent lid, allowing to see the grilling, without opening the lids frequently;
c) Large diameter wheels, which do not sink deep in sand and can be locked against accidental rolling away on slight slopes;
d) Scissor underframe, allowing to raise and lower the grill and lock it at the desired height;
e) Heat insulated handle bar, which can be raised and lowered, and locked at least in two position, but preferably in three; and
f) Accessories, including fix handles for grill raising/lowering, heat insulated handles for lid opening/closing, smoke venting covers with airflow rate adjustor screens, and ash dropping bottom door for easing the cleaning after grilling.

### BRIEF DESCRIPTION OF THE DRAWINGS

Referring to the drawings:

FIG. 1 is a perspective view of a mobile barbecue grill as per the teachings of the invention.

FIG. 2A is a perspective view as the same, with rectangular pot and lids, shown in grilling position.

FIG. 2B is a perspective view as the same, shown in collapsed storage position.

FIG. 3 is an elevation view of another mobile barbecue grill as per the teachings of the invention, with non-collapsible frame.

### DETAILED DESCRIPTION OF A PREFERRED EMBODIMENT

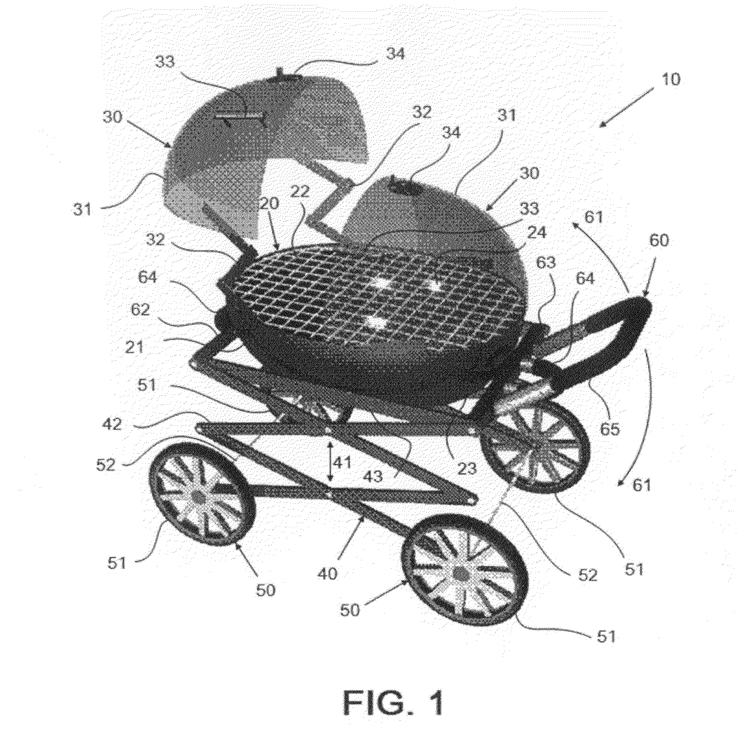

Attention is now turned to FIG. 1, which illustrates in perspective view, Grill 10, a preferable embodiment of the invention.

Grill 10 has grilling Pot 20, Lids 30, under Frame 40, Wheels 50, and Handles 60, as subassemblies.

Pot 20 has dish 21, rack 22, cleaning door 23, and food 24.

Lid 30 has transparent segment 31, collapsible frames 32, insulated handle 33, and adjustable flow air rate vent cover 34.

Frame 40 has upward and downward adjustability 41, scissor frames 42, and locking bars 43.

Wheels 50 has large solid tire wheels 41, and axels 52.

Handle 60 has upturn and downturn mobility 61, tie rod 62, locking flap 63, fix handles 64, and movable handle 65.

Handle 65 turned up or down and preferably locked in such positions facilitates storage by allowing Grill 10 to have small footprint when not in use. Handle 65 also locks in transporting position as shown.

Bars 43 have several holes or ratchet grooves to allow for locking Pot 20 used by tall, regular and short cooks.

Wheels 51 preferably have solid rubber tires, but may have fat inflated tires for sandy beach use.

Handles 64 may be fixed to dish 21 or to rod 62, which may or may not be covered by flap 63. Handles 64 thus may serve Pot 20 removal from Frame 40 for occasional heavy duty cleaning, or just help pulling Grill 10 when its handle 65 is down for storage.

Food 24 may be smoky. The sideway opening of lids 30 prevents heavy smoke getting in the eyes of the cook, even if he/she stays close to Grill 10.

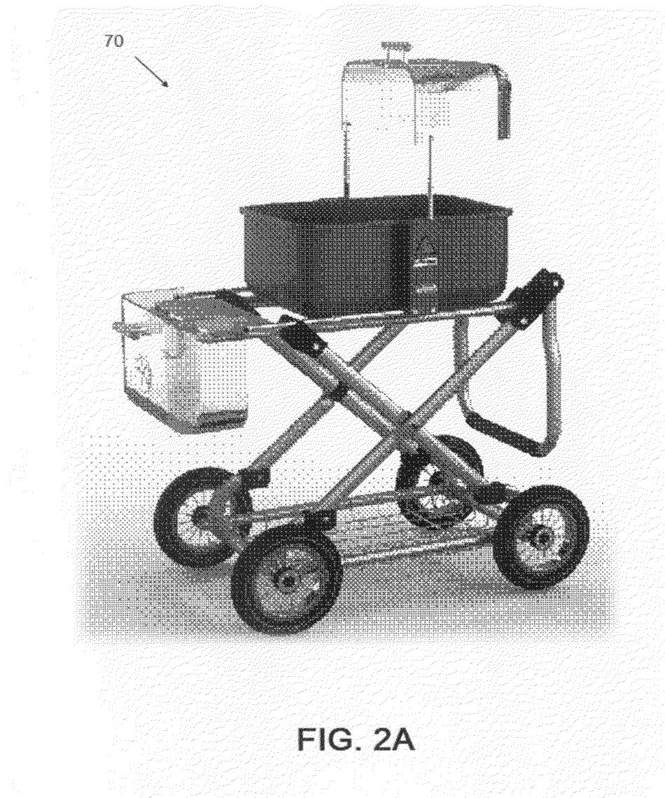

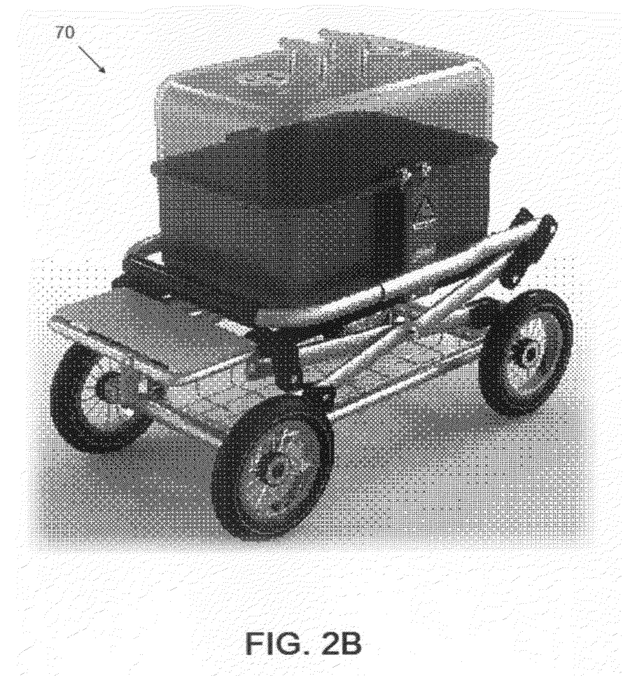

Attention is now turned to FIGS. 2A and 2B, which in perspective photographic view, illustrates Grill 70, which is the same as Grill 10, however with rectangular pot and lids. Grill 70 allows the lids to be raised on standoffs and to be removed from the hinges. It also has a cutting board and a storage rack. FIG. 2A shows Grill 70 in upright grilling position, while FIG. 2B, illustrates it in collapsed storage position.

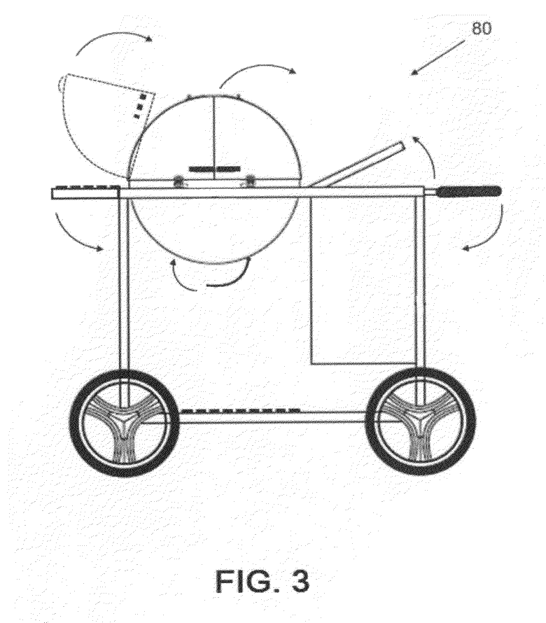

Attention is finally turned to FIG. 3, which, in a side view (elevation), illustrates Grill 80, which is similar to Grill 10 and 70, however with fix (non-collapsible) frame. It has added cutting board, ash cleaning door, ice chest and coal storage rack, all customary or state-of-art features on most grills, thus are not labeled here.

The present invention is described above with reference to a preferred embodiment. However, those skilled in the art will recognize that changes and modifications may be made in the described embodiment without departing from the nature and scope of the present invention. For instance, high mobility grill with non-transparent cover or with covers having peeping holes with window, as well as one side opening single lid is considered intuitive and there by instructive herewith as being within the scope of the invention. Also, the non-scissor type pot lifting mechanisms and the all fixed handles.

Various further changes and modifications to the embodiment herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. Outdoor barbeque grill apparatus having at least one lid opening sideway.

2. Grill as per claim 1, with means to alter and lock grill height.

3. Grill as per claim 1, with means to roll it.

4. Grill as per claim 1, with folding frame.

5. Grill as per claim 1, with means to monitor food grilling without opening said lid.

6. Grill as per claim 1, whereas said lid is transparent at least in part.

7. Grill as per claim 1, whereas said lid is heat resistant glass.

8. Grill as per claim 1, whereas said lid is metal.

9. Grill as per claim 1, having a stationary frame.
